(19) United States
(12) Patent Application Publication
(10) Pub. No.: US 2006/0006610 A1
(43) Pub. Date: Jan. 12, 2006

(54) Gasket for duct, pipe and tube joints

(75) Inventor: Michael Graham, Elmira Heights, NY (US)

Correspondence Address: AQUILLA & ASSOCIATES, 88 LOWER CREEK ROAD, ITHACA, NY, 14850, US

(73) Assignee: Stamped Fittings, Inc., Elmira, NY (US)

(21) Appl. No.: 11/151,786

(22) Filed: Jun. 14, 2005

Related U.S. Application Data
(63) Continuation-in-part of application No. 10/810,935, filed on Mar. 26, 2004.

(51) Int. Cl. F16L 17/00

(52) U.S. Cl. 277/602

(57) ABSTRACT

A gasket or sealing ring designed to fit over an unrolled or unfolded edge of an inner (male) duct section or connector to be joined, for sealing various types of connections between duct sections and/or connectors, includes a sealing ring having a base portion for receiving an end of an inner (male) duct section or connector to be joined and a substantially J-shaped cross-section, and a flexible hollow sealing portion of substantially circular cross-sectional shape affixed to the base portion and protruding in a radially outward direction, for engagement with an outer (female) duct section or connector to be joined. In one embodiment, the base portion also includes a lip protruding in a radially inward direction for engagement with a complimentary groove or depression on the inner (male) duct section to be joined.

### REFERENCE TO RELATED APPLICATIONS

This is a continuation-in-part patent application of copending application Ser. No. 10/810,935, filed Mar. 26, 2004, entitled “IMPROVED GASKET FOR DUCT, PIPE AND TUBE JOINTS”. The complete disclosure of the aforementioned application is hereby incorporated herein by reference in its entirety.

### BACKGROUND OF THE INVENTION

1. Field of the Invention

The invention pertains to the field of interconnecting heating, ventilation and air conditioning (HVAC) ducting sections. More particularly, the invention pertains to an improved gasket for sealing various connections between duct sections.

2. Description of Related Art

Various joint assemblies are well known for the connection of the ends of adjacent rectangular, circular, and oval HVAC duct sections. Typically, such joint assemblies generally comprise one or more connections wherein a first tubular member (such as, e.g. a round or round-oval duct section, or connector therefor), having an outside diameter incrementally less than an inside diameter of a second tubular member, is engaged with the second tubular member by inserting a portion of an end of the first tubular member into a portion of an end of the second tubular member.

In addition, a variety of means are well known for fastening the connections between the ends of adjacent tubular duct sections. One such commonly employed means comprises first and second connectors, one connector attached to each duct section. A flange extends from each connector, and the flanges of the two connectors are fastened together, thereby making the connection. Each connector comprises a tubular member having an inside diameter incrementally less (or greater) than an inside (or outside) diameter of a round or round oval duct Typically, a radially directed annular flange extends from the tubular member. The flanges of the first and second connectors typically are secured together by a plurality of fasteners distributed about the flange. A washer or gasket frequently is carried between the flanges, to improve the seal.

Numerous methods are known for connecting and sealing the connections between the ends of adjacent duct sections. For example, U.S. Pat. Nos. 6,301,781, 6,289,706, and 5,983,496 disclose methods of making circular and oval flanged rings, for connecting and sealing circular and oval duct sections. U.S. Pat. No. 5,129,690 discloses an apparatus for connecting and sealing the ends of oval duct sections. U.S. Patent Publication No. 20020124614A1 discloses a flanged connector for HVAC ducting.

U.S. Patent Publication No. 20020140231A1 discloses an apparatus for connecting and sealing duct sections, adapted for connecting and sealing round ducts, round oval ducts, and other commonly used ducts. The apparatus includes first and second connectors. Each connector includes a tubular member having an outside diameter that is incrementally smaller than the inside diameter of the duct to which it is attached. An O-ring carried in an O-ring channel defined in the tubular member makes an air-tight seal with the duct A radially directed annular flange extends outwardly from an outer end of the tubular member. An outer perimeter of the flange forms a rolled edge. A gasket may be carried between the outer surfaces of adjacent flanges of first and second connectors associated with first and second ducts to be joined. Duct sealer may also be carried between the outer surfaces, with or without a gasket.

U.S. Pat. No. 6,533,332 discloses a sealing gasket for connecting a tubular fitting to a pipe. U.S. Pat. No. 6,457,718 discloses a stepped, stretchable gasket for a pipe joint between mating bell and spigot ends of a metal pipe joint U.S. Pat. No. 6,431,609 discloses a pipe connector and seal for ventilation ducts, consisting of a U-shaped sealing ring retained by a band on the entering pipe. U.S. Pat. No. 6,427,309 discloses a compression seal consisting of an O-ring set into a retaining groove on an outer pipe fitting. The inner fitting carries a flange, which prevents the sharp front edge of the inner fitting from damaging the O-ring. U.S. Pat. No. 5,213,374 discloses a coupling ring comprising an inner duct segment or sleeve over which there are fit two duct segments to be joined. The ends of each of the outer duct segments engage a bead of sealing material. U.S. Pat. No. 5,094,467 discloses a gasket for placement within an outer pipe to be joined. The gasket is characterized by a plurality of locking elements embedded within the gasket for bearing against the outer surface of the male pipe end. U.S. Pat. No. 5,024,454 discloses an annular seal for heat and air conditioning ducts for aircraft The seal is carried on flanges disposed on the male pipe end or the female pipe end. In an alternative embodiment, a double-beaded seal is retained within complimentary circumferential grooves formed on the female pipe end.

The disclosures of each of the foregoing patents and patent publications referred to above in the Description of Related Art section are hereby incorporated herein by reference in their entireties.

Unfortunately, the means known in the prior art for sealing the connection between duct sections suffer from several problems. For example, the prior art sealing means typically are preassembled during the manufacturing stage or prior to shipping to a job site. Therefore, they are susceptible to damage to the seal and/or contamination of the sealing surface with debris during handling, shipping, or storage and thus, the potential for seal failure is increased. Further, in the event that a seal of the prior art is damaged, the damaged seal usually cannot simply be removed and replaced with a new one in the field, (e.g., immediately prior to installation), thus requiring entire permanently assembled units to be discarded. Furthermore, in some applications where duct sealer is used, excess duct sealer is squeezed from between the flanges as the fasteners are tightened, and tends to foul the perimeter of the apparatus. Thus, there is a need in the art for an improved apparatus for sealing adjacent duct sections that can overcome the disadvantages of the prior art.

### SUMMARY OF THE INVENTION

Briefly stated, a gasket or sealing ring for sealing various types of connections between duct sections and/or connectors includes a sealing ring having a base portion for receiving an end of an inner (male) duct section or connector to be joined and a substantially J-shaped cross-section, and a flexible hollow sealing portion of substantially circular cross-sectional shape affixed to the base portion and protruding in a radially outward direction, for engagement with an outer (female) duct section or connector to be joined. In one embodiment, the base portion also includes a lip protruding in a radially inward direction for engagement with an optional complimentary groove or depression on the inner (male) duct section to be joined.

### BRIEF DESCRIPTION OF THE DRAWING

FIG. 1 shows a perspective view of an embodiment of a sealing ring for sealing the connection between duct sections, in use between a pair of round duct sections.

FIG. 2 shows a cross-sectional view of the sealing ring embodiment shown in FIG. 1.

FIG. 3 shows a cross-sectional view of the embodiment shown in FIG. 1, wherein the sealing ring base portion receives and is engaged with the edge of an inner duct section or connector to be joined.

FIG. 4 shows a cross-sectional view of the embodiment shown in FIG. 3, wherein the sealing ring base portion receives and is engaged with the edge of an inner duct section or connector to be joined, depicting the flexible hollow sealing portion in engagement with the inside of an outer (female) duct section or connector, according to the contemplated use of the invention.

FIG. 5 shows a cross-sectional view of an alternative sealing ring embodiment, which lacks the J-shaped element.

### DETAILED DESCRIPTION OF THE INVENTION

The invention provides a gasket or sealing ring for sealing various types of connections between duct sections and/or connectors. The invention provides for the maintenance of a gas-tight seal between tubular duct members that are connected. The sealing ring preferably is adapted for use with conventional duct sections and/or connectors, providing an additional barrier to gas transfer into or out of the connected ducts.

A preferred embodiment includes a sealing ring having a base portion for receiving an end of an inner (male) duct section or connector to be joined and a substantially J-shaped cross-section, and a flexible hollow sealing portion of substantially circular cross-sectional shape affixed to the base portion and protruding in a radially outward direction, for engagement with an outer (female) duct section or connector to be joined. In one embodiment, the base portion also includes a lip protruding in a radially inward direction for engagement with a complimentary groove or depression on the inner (male) duct section to be joined.

In the preferred embodiment, the sealing ring is designed to fit over an unrolled or unfolded edge of an inner (male) duct section or connector to be joined, such that folding or rolling back of the end of the duct section sheet metal (e.g., forming a hem or bead on the end) is not necessary.

The sealing ring of the present invention need not be permanently secured, nor must it be preassembled during the manufacturing stage or prior to shipping to a job site (although optionally it is affixed prior to shipping). The present sealing rings can be applied in the field, e.g., immediately prior to installation, and optionally are permanently or reversibly attached to the duct section or connector to be joined.

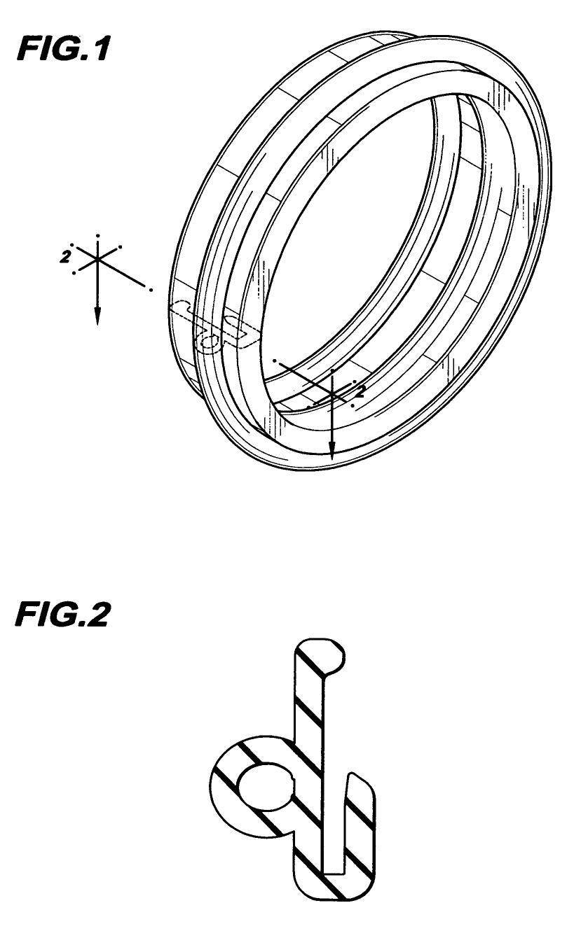

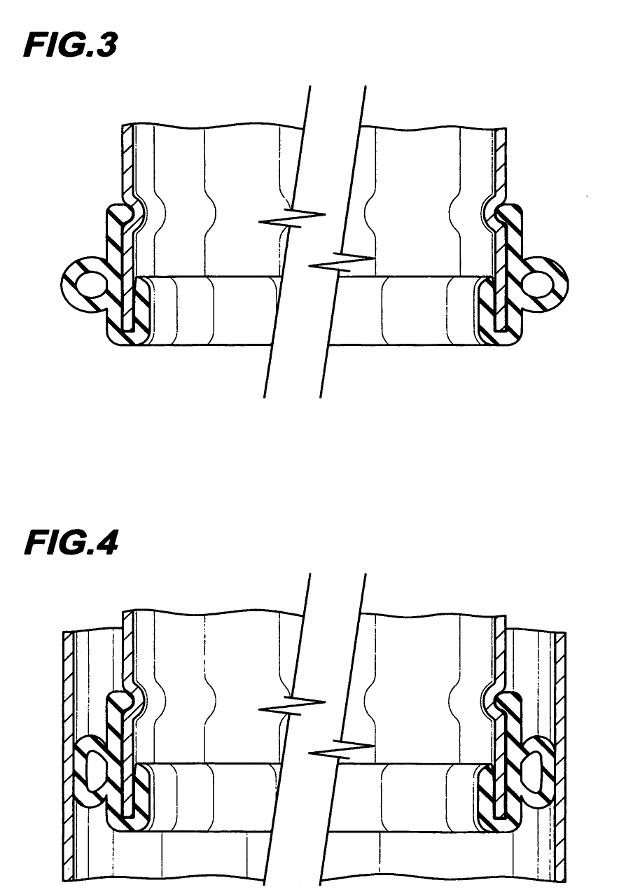

Referring generally to FIGS. 1 through 4, a sealing ring 100 for sealing the connection between duct sections, constructed in accordance with the principles of the invention, is shown. The sealing ring 100 includes a base portion 2 for receiving an edge of an inner (male) duct section 4 or connector to be joined, and a substantially J-shaped cross-section 6, and a flexible hollow sealing portion 8 of substantially circular cross-sectional shape affixed to the base portion 2 and protruding in a radially outward direction, for engagement with an outer (female) duct section 10 or connector to be joined. In a preferred embodiment, the base portion 2 also includes a lip 12 protruding in a radially inward direction for engagement with an optional complimentary groove or depression 14 on the inner (male) duct section to be joined.

The base portion 2 and said flexible hollow sealing portion 8 optionally comprise materials having a different hardness, preferably wherein said base portion 2 is harder than said flexible hollow sealing portion 8.

During manufacturing, the gasket of the invention simply can be extruded in long strips, which easily can be cut to any desired length and easily applied to the duct sections or connectors.

Typically, two ducts are joined using the present invention in the following manner. The sealing ring 100 is fitted onto the unrolled or unhemmed edge of the end of an inner (male) duct section 4 or connector. The end of the inner (male) duct section 4 or connector is incrementally smaller in diameter than the end of the outer (female) duct section 10 or connector, to which it is to be attached. The end of the inner (male) duct section 4 or connector is inserted partially into the end of the outer (female) duct section 10 or connector, such that the sealing ring 100 makes a generally airtight seal with the duct The connection between the duct sections or connectors is then fastened, using known conventional means.

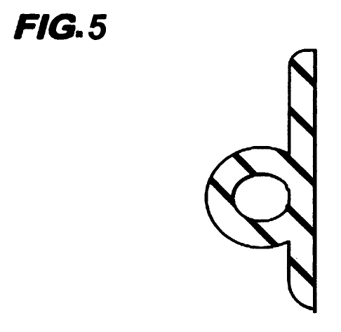

Referring now to FIG. 5, an alternative embodiment is shown, which lacks the J-shaped element This embodiment is affixed around the tube to be sealed, rather than being affixed on the end of the sheet metal fitting, but shares the same advantages and optional features as shown in prior embodiments. Although the embodiment depicted in FIG. 5 shows the circular cross-sectional flexible hollow sealing portion affixed to the base portion off-center, the circular cross-sectional sealing portion optionally is affixed to the base portion at any location on its surface. The embodiment of FIG. 5 preferably is cut to the desired length and secured to the tube to be sealed using a small amount of glue, epoxy or duct sealer, for example, prior to fastening the joint.

The advantages of the present invention provide an improvement over prior art duct sealing means. For example, the sealing ring of the present invention is adapted for use with conventional duct sections, providing an additional barrier to gas transfer into or out of the connected ducts. The sealing ring is not required to be affixed to the duct sections or connectors during the manufacturing stage or prior to shipping to a job site (although optionally it is affixed prior to shipping). Therefore, the present invention is less susceptible to damage to the seal and/or contamination of the sealing surface with debris during handling, shipping, or storage and thus, the potential for seal failure is reduced. Further, in the event that a seal of the present invention is damaged, the damaged seal can simply be removed and replaced with a new one in the field, (e.g., immediately prior to installation), thus obviating the need to discard entire permanently assembled units. Furthermore, duct sealer is not required when the present invention is employed, thus, excess duct sealer does not foul the perimeter of the apparatus. Thus, the invention overcomes the disadvantages of the prior art

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A gasket for sealing duct sections, comprising:
a sealing ring having a base portion for contacting an inner duct section or connector to be joined; and
a flexible hollow sealing portion of substantially circular cross-sectional shape affixed to said base portion and protruding in a radially outward direction, for engagement with an outer duct section or connector to be joined.

2. The gasket of claim 1, wherein said base portion also includes a lip protruding in a radially inward direction for engagement with a complimentary groove or depression on said inner duct section or connector to be joined.

3. The gasket of claim 1, wherein said base portion and said flexible hollow sealing portion comprise materials having a different hardness.

4. The gasket of claim 3, wherein said base portion is harder than said flexible hollow sealing portion.

5. The gasket of claim 1, wherein said base portion is removably fitted onto an unrolled or unfolded edge of said inner duct section or connector.

6. The gasket of claim 1, wherein said base portion is permanently secured onto an unrolled or unfolded edge of said inner duct section or connector.

7. The gasket of claim 2, wherein said base portion and said flexible hollow sealing portion comprise materials having a different hardness.

8. The gasket of claim 7, wherein said base portion is harder than said flexible hollow sealing portion.

9. The gasket of claim 7, wherein said base portion is removably fitted onto an unrolled or unfolded edge of said inner duct section or connector.

10. The gasket of claim 7, wherein said base portion is permanently secured onto an unrolled or unfolded edge of said inner duct section or connector.

11. The gasket of claim 8, wherein said base portion is removably fitted onto an unrolled or unfolded edge of said inner duct section or connector.

12. The gasket of claim 8, wherein said base portion is permanently secured onto an unrolled or unfolded edge of said inner duct section or connector.

13. A gasket for sealing duct sections, comprising:
a sealing ring having a base portion for receiving an end of an inner duct section or connector to be joined, and a substantially J-shaped cross-section; and
a flexible hollow sealing portion of substantially circular cross-sectional shape affixed to said base portion and protruding in a radially outward direction, for engagement with an outer duct section or connector to be joined.

14. The gasket of claim 13, wherein said base portion also includes a lip protruding in a radially inward direction for engagement with a complimentary groove or depression on said inner duct section or connector to be joined.

15. The gasket of claim 13, wherein said base portion and said flexible hollow sealing portion comprise materials having a different hardness.

16. The gasket of claim 15, wherein said base portion is harder than said flexible hollow sealing portion.

17. The gasket of claim 13, wherein said base portion is removably fitted onto an unrolled or unfolded edge of said inner duct section or connector.

18. The gasket of claim 13, wherein said base portion is permanently secured onto an unrolled or unfolded edge of said inner duct section or connector.

19. The gasket of claim 14, wherein said base portion and said flexible hollow sealing portion comprise materials having a different hardness.

20. The gasket of claim 19, wherein said base portion is harder than said flexible hollow sealing portion.
